(19) United States
(12) Patent Application Publication
(10) Pub. No.: US 2023/0119616 A1
(43) Pub. Date: Apr. 20, 2023

(54) DISCOVERY POOL FOR SIDELINK

(71) Applicant: QUALCOMM Incorporated, San Diego, CA (US)

(72) Inventors: Peng CHENG, Beijing (CN); Karthika PALADUGU, San Diego, CA (US); Hong CHENG, Basking Ridge, NJ (US); Sudhir Kumar BAGHEL, Pleasanton, CA (US); Kapil GULATI, Belle Mead, NJ (US); Gavin Bernard HORN, La Jolla, CA (US); Seyedkianoush HOSSEINI, San Diego, CA (US); Junyi LI, Fairless Hills, PA (US); Dan VASSILOVSKI, Del Mar, CA (US)

(21) Appl. No.: 17/905,810

(22) PCT Filed: Apr. 8, 2020
(86) PCT No.: PCT/CN2020/083737

§ 371 Date: Sep. 7, 2022

(51) Int. Cl. H04W 76/14; H04W 8/00; H04W 76/28

(52) U.S. Cl. CPC H04W 76/14; H04W 8/005; H04W 76/28

(57) ABSTRACT

Certain aspects provide a method for wireless communication by a first user-equipment (UE). The method generally includes determining a first configuration for communication with a second UE of one or more discovery messages on a sidelink channel and a second configuration for data communication with the second UE on the sidelink channel, wherein the first configuration is different than the second configuration, and communicating with the second UE in accordance with at least one of the first configuration or the second configuration.

### BACKGROUND

### Field of the Disclosure

Aspects of the present disclosure relate to wireless communications, and more particularly, to techniques for sidelink communication.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved feedback signaling.

Certain aspects provide a method for wireless communication by a first user-equipment (UE). The method generally includes determining a first configuration for communication with a second UE of one or more discovery messages on a sidelink channel and a second configuration for data communication with the second UE on the sidelink channel, wherein the first configuration is different than the second configuration, and communicating with the second UE in accordance with at least one of the first configuration or the second configuration.

Certain aspects provide a method for wireless communication. The method generally includes determining a first configuration for communication of one or more discovery messages on a sidelink channel between a first UE and a second UE and a second configuration for data communication on the sidelink channel, wherein the first configuration is different than the second configuration, and transmitting an indication of the first configuration and the second configuration.

Certain aspects provide an apparatus for wireless communication by a first user-equipment (UE). The apparatus generally includes a processing system configured to determine a first configuration for communication with a second UE of one or more discovery messages on a sidelink channel and a second configuration for data communication with the second UE on the sidelink channel, wherein the first configuration is different than the second configuration, and a transceiver configured to communicate with the second UE in accordance with at least one of the first configuration or the second configuration.

Certain aspects provide an apparatus for wireless communication. The apparatus generally includes a processing system configured to determine a first configuration for communication of one or more discovery messages on a sidelink channel between a first UE and a second UE and a second configuration for data communication on the sidelink channel, wherein the first configuration is different than the second configuration, and a transmitter configured to transmit an indication of the first configuration and the second configuration.

Certain aspects provide an apparatus for wireless communication by a first user-equipment (UE). The apparatus generally includes means for determining a first configuration for communication with a second UE of one or more discovery messages on a sidelink channel and a second configuration for data communication with the second UE on the sidelink channel, wherein the first configuration is different than the second configuration, and means for communicating with the second UE in accordance with at least one of the first configuration or the second configuration.

Certain aspects provide an apparatus for wireless communication. The apparatus generally includes means for determining a first configuration for communication of one or more discovery messages on a sidelink channel between a first UE and a second UE and a second configuration for data communication on the sidelink channel, wherein the first configuration is different than the second configuration, and means for transmitting an indication of the first configuration and the second configuration.

Certain aspects provide a computer-readable medium having instructions stored thereon to cause a first user-equipment (UE) to determine a first configuration for communication with a second UE of one or more discovery messages on a sidelink channel and a second configuration for data communication with the second UE on the sidelink channel, wherein the first configuration is different than the second configuration, and communicate with the second UE in accordance with at least one of the first configuration or the second configuration.

Certain aspects provide a computer-readable medium having instructions stored thereon to cause an apparatus to determine a first configuration for communication of one or more discovery messages on a sidelink channel between a first UE and a second UE and a second configuration for data communication on the sidelink channel, wherein the first configuration is different than the second configuration, and transmit an indication of the first configuration and the second configuration.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example a base station (BS) and user equipment (UE), in accordance with certain aspects of the present disclosure.

FIGS. 3A and 3B show diagrammatic representations of example vehicle to everything (V2X) systems in accordance with some aspects of the present disclosure.

FIGS. 4A and 4B illustrate messages for discovery in sidelink.

FIG. 5 illustrates a protocol 500 for relay selection, in accordance with certain aspects of the present disclosure.

FIG. 6 is a flow diagram illustrating example operations for wireless communication, in accordance with certain aspects of the present disclosure.

FIG. 7 is a flow diagram illustrating example operations for wireless communication, in accordance with certain aspects of the present disclosure.

FIG. 8 illustrates a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for configuring sidelink discovery and data communication. For example, in some aspects, various configurations for performing discovery and data communication may be configured separately. These configurations may include resources for discovery and data communication, power control configurations, power saving configurations, periodicity, priority, or any combination thereof. Some aspects provide techniques for signaling configurations to UEs. For instance, configurations may be signaled using radio resource control (RRC) signaling, or system information block (SIB). One or more bits may be included to distinguish resources being configured for discovery from resources being configured for data communication, as described in more detail herein.

The following description provides examples of configurations for SL communication in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

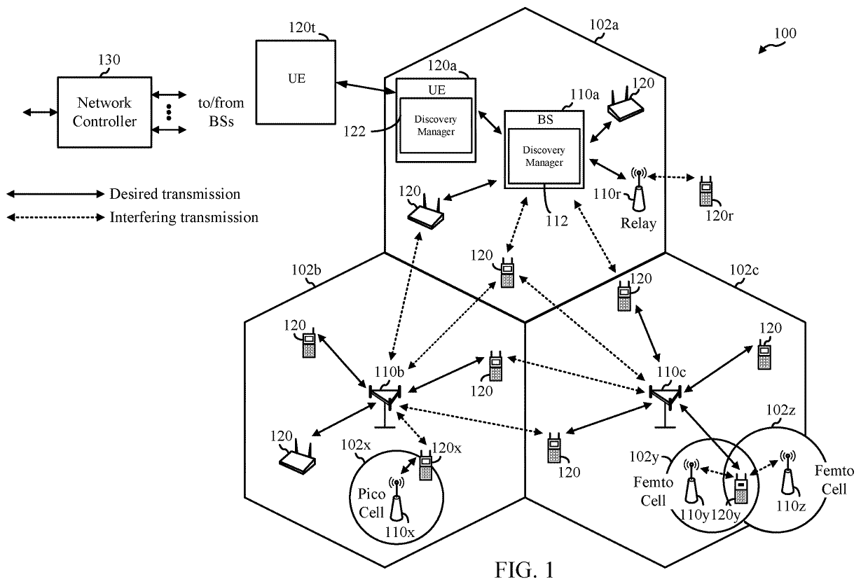

FIG. 1 illustrates an example wireless communication network 100 in which aspects of the present disclosure may be performed. For example, the wireless communication network 100 may be an NR system (e.g., a 5G NR network).

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

According to certain aspects, the UEs 120 may be configured to perform discovery operations. As shown in FIG. 1, the UE 120a includes a discovery manager 122. The discovery manager 122 may be configured to determine a first configuration for communication with a second UE (e.g., UE 120t) of one or more discovery messages on a sidelink channel and a second configuration for data communication with the second UE on the sidelink channel, the first configuration being different than the second configuration, and communicating with the second UE in accordance with at least one of the first configuration or the second configuration, as described in more detail herein. The BS 110a includes a discovery manager 112. The discovery manager 112 may be configured to determine a first configuration for communication of one or more discovery messages on a sidelink channel between a first UE (e.g., UE 120a) and a second UE (e.g., UE 120t) and a second configuration for data communication on the sidelink channel, wherein the first configuration is different than the second configuration, and transmit an indication of the first configuration and the second configuration.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

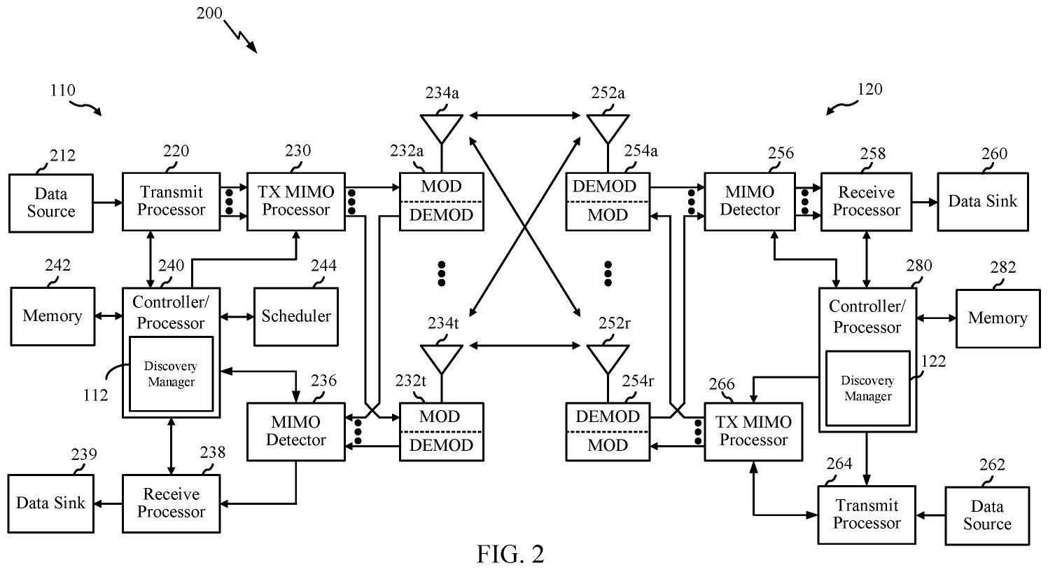

FIG. 2 illustrates example components of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

The controller/processor 280 and/or other processors and modules at the UE 120a may perform or direct the execution of processes for the techniques described herein. As shown in FIG. 2, the controller/processor 280 of the UE 120a has the discovery manager 122, and the controller/processor 280 of the BS 110 has the discovery manager 112. Although shown at the Controller/Processor, other components of the UE 120a may be used performing the operations described herein.

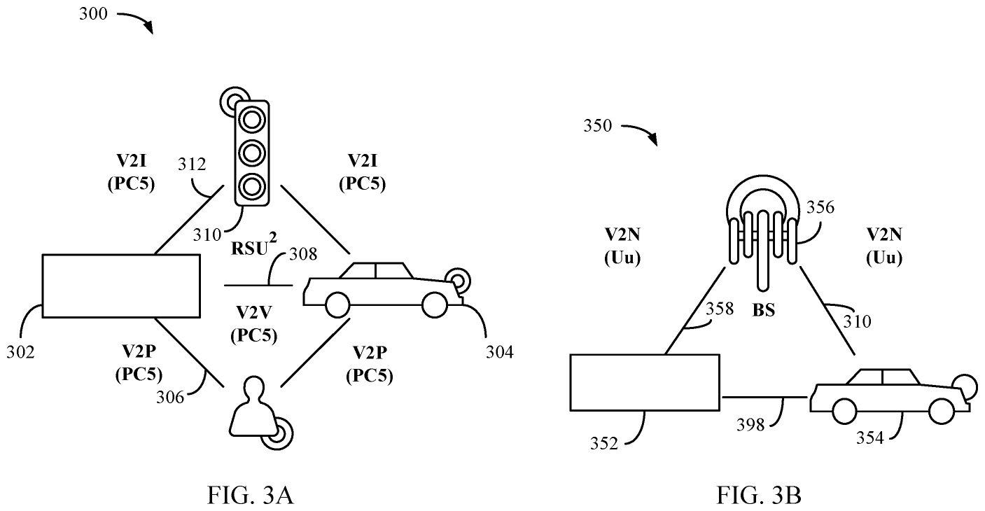

FIGS. 3A and 3B show diagrammatic representations of example vehicle to everything (V2X) systems in accordance with some aspects of the present disclosure. For example, the UEs shown in FIGS. 3A and 3B may communicate via sidelink channels and may perform sidelink CSI reporting as described herein.

The V2X systems, provided in FIGS. 3A and 3B provide two complementary transmission modes. A first transmission mode, shown by way of example in FIG. 3A, involves direct communications (for example, also referred to as side link communications) between participants in proximity to one another in a local area. A second transmission mode, shown by way of example in FIG. 3B, involves network communications through a network, which may be implemented over a Uu interface (for example, a wireless communication interface between a radio access network (RAN) and a UE). As illustrated, UEs 352, 354 may communicate with each other using a sidelink (SL) 398.

Referring to FIG. 3A, a V2X system 300 (for example, including vehicle to vehicle (V2V) communications) is illustrated with two UEs 302, 304 (e.g., vehicles). The first transmission mode allows for direct communication between different participants in a given geographic location. As illustrated, a vehicle can have a wireless communication link 306 with an individual (V2P) (for example, via a UE) through a PC5 interface. Communications between the UEs 302 and 304 may also occur through a PC5 interface 308. In a like manner, communication may occur from a UE 302 to other highway components (for example, highway component 310), such as a traffic signal or sign (V2I) through a PC5 interface 312. With respect to each communication link illustrated in FIG. 3A, two-way communication may take place between elements, therefore each element may be a transmitter and a receiver of information. The V2X system 300 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 3B shows a V2X system 350 for communication between a UE 352 (e.g., vehicle) and a UE 354 (e.g., vehicle) through a network entity 356. These network communications may occur through discrete nodes, such as a base station (for example, an eNB or gNB), that sends and receives information to and from (for example, relays information between) UEs 352, 354. The network communications through vehicle to network (V2N) links (e.g., Uu links 358 and 310) may be used, for example, for long range communications between vehicles, such as for communicating the presence of a car accident a distance ahead along a road or highway. Other types of communications may be sent by the node to vehicles, such as traffic flow conditions, road hazard warnings, environmental/weather reports, and service station availability, among other examples. Such data can be obtained from cloud-based sharing services.

In some circumstances, two or more subordinate entities (for example, UEs) may communicate with each other using sidelink signals. As described above, V2V and V2X communications are examples of communications that may be transmitted via a sidelink. Other applications of sidelink communications may include public safety or service announcement communications, communications for proximity services, communications for UE-to-network relaying, device-to-device (D2D) communications, Internet of Everything (IoE) communications, Internet of Things (IoT) communications, mission-critical mesh communications, among other suitable applications. Generally, a sidelink may refer to a direct link between one subordinate entity (for example, UE1) and another subordinate entity (for example, UE2). As such, a sidelink may be used to transmit and receive a communication (also referred to herein as a “sidelink signal”) without relaying the communication through a scheduling entity (for example, a BS), even though the scheduling entity may be utilized for scheduling or control purposes. In some examples, a sidelink signal may be communicated using a licensed spectrum (unlike wireless local area networks, which typically use an unlicensed spectrum).

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions. The PSFCH may carry feedback such as channel state information (CSI) related to a sidelink channel quality.

### Example Techniques for Configuring a Discovery Pool for Sidelink

Certain aspects of the present disclosure to techniques for configuring a pool of resources for discovery (also referred to as a discovery pool) to be used for sidelink communication. Discovery operations as described herein are used by remote UEs to connect to another UE (e.g., a relay UE) for data communication. As used herein, data communication generally refers to data communication and feedback between UEs based on an established link. In certain aspects of the present disclosure, resources for discovery may be configured separately from resources to be used for communication in sidelink, as described in more detail herein.

For long-term evolution (LTE), discovery pool and communication pool may be separately configured in a radio resource control (RRC) reconfiguration message, system information block (SIB), or may be preconfigured (e.g., in a standard). For example, common communication pools may be provided in LTE SIB18, and common discovery pools may be provided in LTE SIB19, for UE's in idle mode of operation. A common pool of resources generally refers to resources available to multiple UEs for a particular purpose (e.g., data communication or discovery). Common communication and discovery pools may be separately provided in pre-configuration for out-of-coverage (OOC) UEs. Dedicated communication and discovery pools may be separately provided in RRC reconfiguration message for UEs in a connected mode of operation. A dedicated pool of resources generally refers to a resources dedicated to a particular UE for communication or discovery.

In some cases, transmit (TX) and receive (RX) pools may be configured. For example, a common TX pool may be configured in SIB or preconfigured. The common TX pool may be overwritten by dedicated configuration via RRC reconfiguration message. RX pool may always be common across UEs for LTE, and may be only provided (e.g., configured) via RRC message upon handover (HO). An RX pool may be agnostic to the RRC state of the UE. In some implementations, dedicated assignment of resources may only be configured for a TX pool.

There are various differences between discovery and communication pools. For example, sidelink control information (SCI) may not be used for discovery messages. Both communication and discovery pools may be defined by a periodic subframe pool of resources in time domain and periodic pool of resource blocks (RBs) pool in frequency domain. Communication pool and discovery pool may share the same RB pool definition in LTE. For example, the bandwidth for discovery and communication pools may be 2 RB to 200 RB, and the start position of the pools of resources may be configurable. For a communication pool, separate frequency allocations may be defined for control and data transmissions. The communication pool and discovery pool may use different periodicity configurations. For instance, the periodicity of communication pool may be 40 ms to 320 ms, but the periodicity for discovery pool may be 320 ms to 10.24 seconds. In other words, communication pools may be denser than discovery pools.

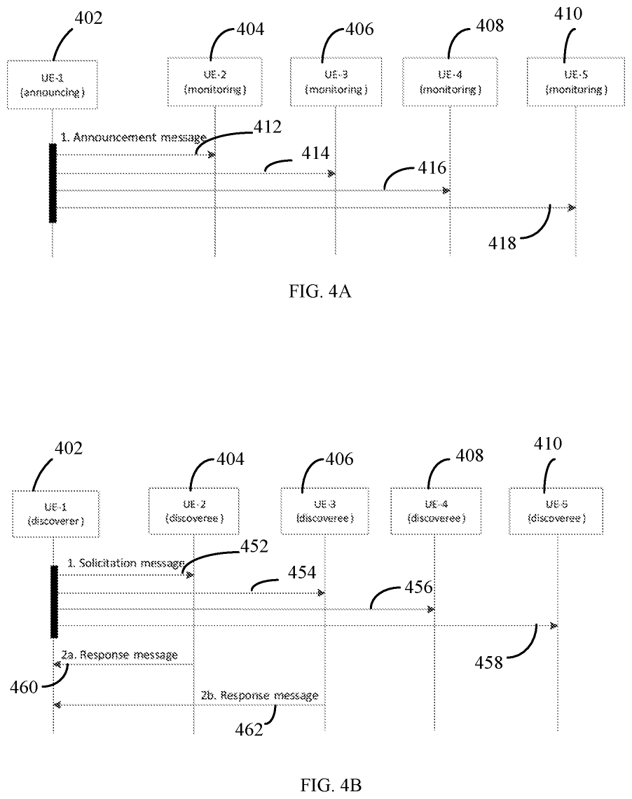

FIGS. 4A and 4B illustrate messages for discovery in sidelink. FIG. 4A illustrates a discovery protocol referred to as “Model A” discovery. As illustrated, UE 402 may transmit announcement messages 412, 414, 416, 418 using a pool of resources configured for discovery. The announcement messages may be received by other UEs 404, 406, 408, 410 that may be monitoring for the announcement messages. The announcement messages may be sent in a PC5 communication channel, as described with respect to FIG. 3. Once received, one or more of the announcement messages may be used for the UE 402 to connect with one or more of UEs 404, 406, 408, 410.

FIG. 4B illustrates a discovery protocol referred to as “Model B” discovery. As illustrated, UE 402 may be a discoverer UE and may be transmitting solicitation messages 452, 454, 456, 458. The solicitation messages may be received by one or more UEs 404, 406, 408, 410. For example, as illustrated, UE 404 and UE 406 may transmit response messages 460, 462 back to UE 402 to facilitate connection on sidelink. For instance, the UE 402 may perform channel measurements to select one of the UEs 404, 406 having the highest link quality, and perform connection establishment with the selected UE.

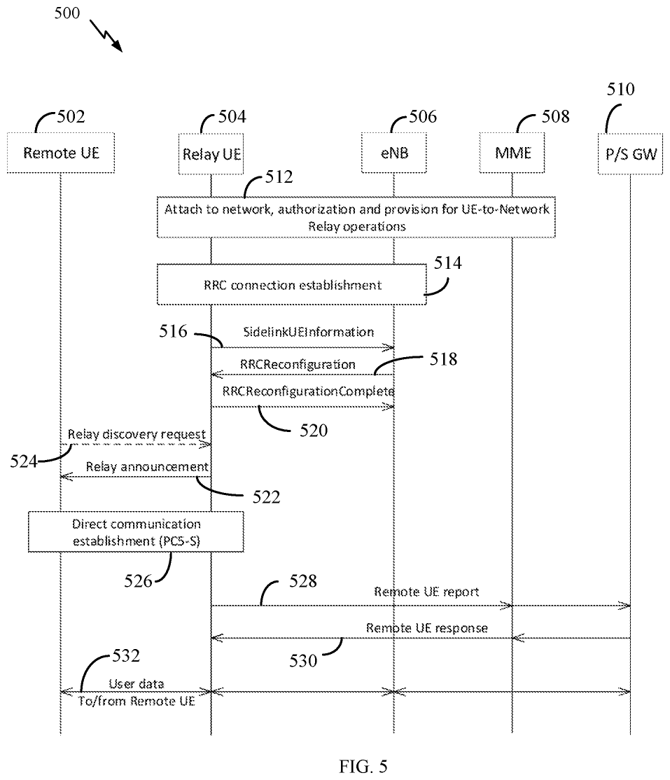

FIG. 5 illustrates a protocol 500 for relay selection, in accordance with certain aspects of the present disclosure. As illustrated, a UE 504 may act as a relay UE to relay data between the UE 502 and the network (e.g., gateway (GW) 510). For example, at block 512, the UE 504 may attached to the network, and perform authorization and provision for UE to network relay operations. At block 514, the UE 504 may establish RRC connection with base station 506 (e.g., eNB). The UE 504 may then transmit sidelink UE information 516 to base station 506, receive RRC reconfiguration message 518, and transmit RRC reconfiguration complete message 520.

Once RRC reconfiguration has been completed, discovery operations may be performed. The remote UE 502 may identify the presence of at least one suitable relay UE to request relay service in its proximity. The relay UE is identified via a discovery message. For example, the relay UE may announce its presence by transmitting sidelink (SL) discovery messages periodically (e.g., in accordance with Model A discovery) or the remote UE may transmit a SL discovery solicitation message, expecting a relay nearby to respond (e.g., in accordance with Model B discovery).

For example, the relay UE 504 may transmit a relay announcement 522 to a remote UE 502. The relay announcement 522 may correspond to one of announcement messages 412, 414, 416, 418 described with respect to FIG. 4A. In some cases, the relay announcement 522 may correspond to one of response messages 460, 462 described with respect to FIG. 4B. For example, for Model B discovery, the remote UE 502 may transmit a relay discovery request 524 (e.g., corresponding to one of solicitation messages 452, 454, 456, 458), and the relay announcement 522 may be in response to the relay discovery request 524. At block 526, direct communication may be established based on the relay announcement 522. In other words, during relay discovery, the remote UE 502 obtains the UE ID of the relay UE 504 to be used for SL transmission and reception of the relayed traffic.

As illustrated, the relay UE 504 may transmit a remote UE report 528 to the Mobility Management Entity (MME) 508 indicating that the relay UE will be acting as a relay for remote UE 502. The relay UE 504 may then receive a remote UE response 530, after which user data 532 may be communicated between the remote UE 502 and the network with the relay UE 504 acting as a relay.

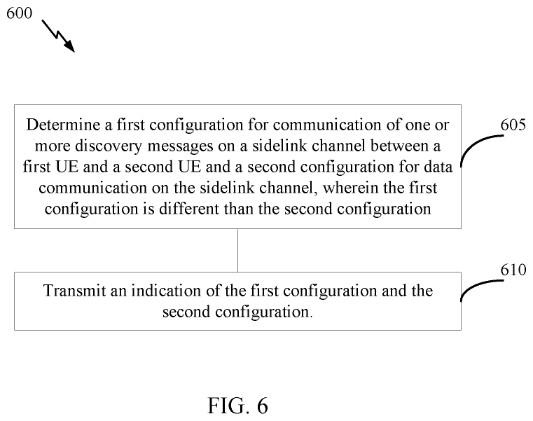

FIG. 6 is a flow diagram illustrating example operations 600 for wireless communication, in accordance with certain aspects of the present disclosure. The operations 600 may be performed, for example, by a BS (e.g., such as the BS 110a in the wireless communication network 100).

Operations 600 may be implemented as software components that are executed and run on one or more processors (e.g., controller/processor 240 of FIG. 2). Further, the transmission and reception of signals by the BS in operations 600 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 600 may begin, at block 605, by the BS determining a first configuration for communication of one or more discovery messages on a sidelink channel between a first UE and a second UE and a second configuration for data communication on the sidelink channel. In certain aspects of the present disclosure, the first configuration may be different than the second configuration. At block 610, the BS transmits an indication of the first configuration and the second configuration.

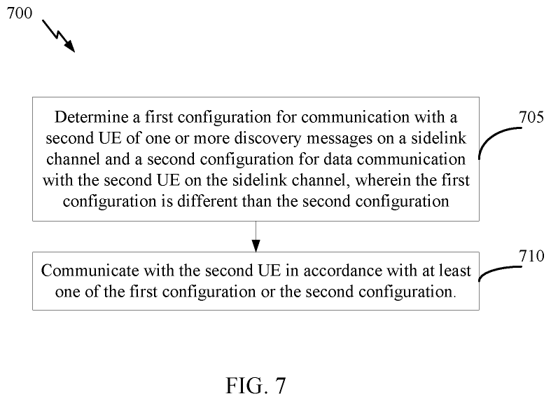

FIG. 7 is a flow diagram illustrating example operations 700 for wireless communication, in accordance with certain aspects of the present disclosure. The operations 700 may be performed, for example, by a first UE (e.g., such as a UE 120t in the wireless communication network 100).

Operations 700 may be implemented as software components that are executed and run on one or more processors (e.g., controller/processor 280 of FIG. 2). Further, the transmission and reception of signals by the first UE in operations 700 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 700 may begin, at block 705, by the first UE determining a first configuration for communication with a second UE of one or more discovery messages on a sidelink channel and a second configuration for data communication with the second UE on the sidelink channel. In certain aspects, the first configuration may be different than the second configuration. In certain aspects, determining the first and second configuration may involve receiving indication of the first and second configurations from a base station. At block 710, the first UE communicates with the second UE in accordance with at least one of the first configuration or the second configuration. In other words, the first UE may transmit or receive discovery messages to establish connection with the second UE. After connection is established, the first UE may use the second configuration for data communication to communicate with the second UE.

In some cases, physical sidelink control channel (PSCCH) and physical sidelink shared channel (PSSCH) may be used for transmission of discovery messages. In certain aspects of the present disclosure, discovery resource pool may be configured separately from the communication channel. In other words, separate discovery and communication resource pools may be configured. In this manner, collision between communication and discovery messages may be reduced.

In certain aspects, separate power saving schemes may be used for discovery and communication resource pools. For instance, the first configuration for communication of the one or more discovery messages may be a first DRX pattern, and the second configuration for data communication may be a second DRX pattern, the first DRX pattern being different than the second DRX pattern. That is, different discontinuous reception (DRX) patterns may be configured for discovery and communication pools.

In some aspects, separate power control schemes may be used. For example, determining the first configuration for discovery may include determining a first power control scheme for the communication of the one or more discovery message, and determining the second configuration for data communication may include determining a second power control scheme for the data communication, the first power control scheme being different than the second power control scheme. In some aspects, determining the first configuration may include determining to transmit the one or more discovery messages using maximum transmit power. In other words, discovery messages may be configured for transmission using maximum transmit power while for communication, which may be unicast, a power-controlled scheme (e.g., open loop power control or closed loop power control) may be used.

In certain aspects, different time and frequency resources may be configured for discovery and communication pools. For example, the first configuration for discovery may include a configuration of first resources for the communication of the one or more discovery messages, and the second configuration for the data communication may include a configuration of second resources for the data communication, the first resources being a different time and frequency than the second resources. In other aspects, the discovery pool and communication pool may share the same time and frequency resources. In this case, it may be up to network implementation to configure a longer periodicity for the discovery pool as compared to periodicity for the communication pool. For example, the first configuration for discovery may include a configuration of a longer periodicity for the communication of the one or more discovery messages as compared to a periodicity for the data communication.

In certain aspects, different discovery priority levels may be configured for different services. For example, a relay UE and a remote UE may obtain a service code from the network. The service code may indicate a quality of service (QoS) associated with a service for which discovery operations are implemented. In other words, discovery messages may have different QoS and latency specifications, and may be configured with different periodicities accordingly. For example, discovery messages configured for a service with low latency specification may be configured with a shorter periodicity, allowing faster discovery between UEs.

In certain aspects, discovery pools may be configured via a system information block, RRC message, or preconfigured at the UE (e.g., included in a standard). To achieve resource pool separation, distinction may be implemented in resource pool configuration. For example, 1-bit indication may be included in a configuration message (e.g., SIB or RRC) indicating whether certain resources being scheduled is for discovery. For example, the first UE, as described with respect to FIG. 7, may receive one or more messages indicating the first configuration for the communication of the one or more discovery messages and the second configuration for the data communication. The one or more messages may include a message scheduling resources for the communication of the discovery messages, the message having a bit indicating that the resources being scheduled are to be used for discovery. In certain aspects, the one or more messages may include a message scheduling resources, the message having at least two bits indicating that the resources being scheduled are to be used for discovery only, data communication only, or for either discovery or data communication. In other words, a 2-bit indication may be included in a configuration message indicating whether certain resources being scheduled is for discovery and communication, discovery only, or communication only.

When adding a 1-bit or 2-bit indication in configuration message, discovery pool configuration and communication pool configuration may be included in the same message (e.g., SIB). For example, a resource pool for V2X communication on sidelink may be configured via SIB. The configuration implementation for V2X using SIB may be used, but with additional one or more bits to configure certain resources for discovery.

In certain aspects, a separate resource pool configuration may be used for discovery. For example, discovery pool configuration may be included in a different SIB than a communication pool configuration. That is, the one or more messages including the first configuration for discovery and the second configuration for data communication may include a first message (e.g., first SIB) indicating the first configuration for the communication of the one or more discovery messages and a second message (e.g., second SIB) indicating the second configuration for the data communication.

In certain aspects, the configuration for the discovery pool may be provided in SIB (e.g., for in coverage UE), or preconfigured (e.g., for out-of-coverage (OOC) UE). In some cases, TX pool (e.g., resources for transmission by a UE) may be modified by a dedicated configuration via an RRC reconfiguration message (e.g., RRC reconfiguration message 518) for RRC-connected UEs. In certain aspects, an RX pool (e.g., resources for reception by a UE) may be agnostic to the RRC state, and thereby may only be indicated in RRC reconfiguration message upon handover (HO) from one cell to another. RX pool and TX pool generally refer to resources used for reception and transmission, respectively. For example, a network may configure one UE with resources for reception (RX pool), and another UE with the same resources for transmission (TX pool).

In certain aspects, separate power control for discovery and communication may be configured. As described herein, discovery may be used for remote UEs to connect to a relay UE, whereas communication may be based on an established link and feedback. In certain aspects, separate power control configuration for discovery TX pool and communication TX pool may be used. For example, discovery announcement may use maximum power while communication may be power controlled (e.g., using open loop or closed loop power control).

In certain aspects, prioritization rules may be configured for discovery transmission and transmissions for data communication. That is, the discovery pool may be frequency division multiplexed (FDMed) with the communication pool and a UE may end up in a scenario where in one slot, the UE has to perform both discovery and data communications. However, due to certain limitations, the UE may be unable to perform both discovery and data communication in the same slot. As another example, sidelink communication may be configured using a semi static grant, and therefore, the transmission for communication may collide with (e.g., configured with the same resources as) transmissions for discovery.

In such as a scenario, configured prioritization rules may be used to select whether discovery or data communication is to be performed in the slot. For example, communication transmission may be prioritized over discovery based on a direct comparison between associated logical channel (LCH) priorities. In other words, a priority may be configured for a LCH for discovery and a priority may be configured for a LCH for communication. The priorities for discovery and data communication may be extracted from medium access control (MAC)-control element (CE) headers of corresponding LCHs. In certain aspects, QoS (e.g., LCH priority or 5G QoS indicator (5QI)) associated with discovery may be compared with a threshold. For example, if QoS associated with discovery is lower than the threshold, the data communication may be prioritized. In certain aspects, QoS (e.g., LCH priority or 5QI) associated with communication may be compared with a threshold. For example, if the QoS associated with data communication is higher than the threshold, the data communication may be prioritized.

Certain aspects of the present disclosure provide rules for prioritization of physical sidelink feedback channel (PSFCH) and discovery. Data communication as described herein may communication of feedback on PSFCH. The feedback may include, for example, acknowledgment (ACK) or negative ACK (NACK) for data received on a physical sidelink shared channel (PSSCH). The priority associated with PSFCH may be the priority of the associated PSSCH. In other words, if feedback transmission on PSFCH collides with discovery transmission, the priority associated with the discovery may be compared with the priority associated with the PSSCH for which feedback is to be transmitted on PSFCH.

In certain aspects, the transmission on PSFCH may already be sent to lower layers for transmission when the colliding discovery message is ready for transmission. In such a scenario, PSFCH transmission may not be suspended (e.g., even if the priority associated with the discovery message is higher). In certain aspects, a transmission on a sidelink broadcast channel (SL-BCH) may collide with discovery or communication messages. In this case, the transmission on the SL-BCH may be prioritized over transmission for discovery or communication.

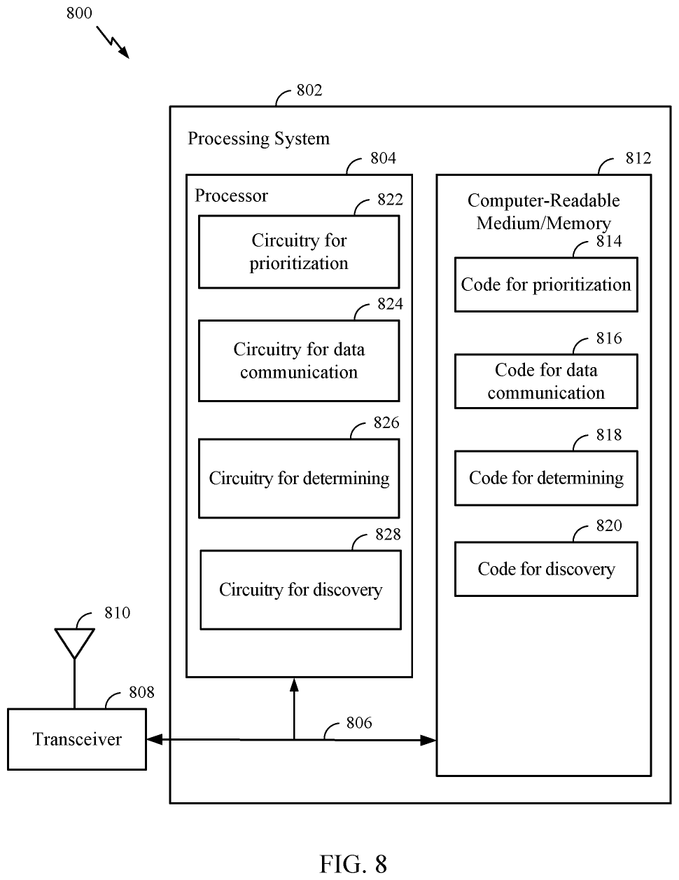

FIG. 8 illustrates a communications device 800 that may include various components (e.g., corresponding to means-plus-function components) configured to perform operations for the techniques disclosed herein, such as the operations illustrated in FIGS. 6 and 7. The communications device 800 includes a processing system 802 coupled to a transceiver 808. The transceiver 808 is configured to transmit and receive signals for the communications device 800 via an antenna 810, such as the various signals as described herein. The processing system 802 may be configured to perform processing functions for the communications device 800, including processing signals received and/or to be transmitted by the communications device 800.

The processing system 802 includes a processor 804 coupled to a computer-readable medium/memory 812 via a bus 806. In certain aspects, the computer-readable medium/memory 812 is configured to store instructions (e.g., computer-executable code) that when executed by the processor 804, cause the processor 804 to perform the operations illustrated in FIGS. 6 and 7. In certain aspects, computer-readable medium/memory 812 stores code 814 for prioritization (e.g., selection a message to transmit); code 816 for data receiving/transmitting (e.g., data communicating), code 818 for determining a configuration, and code 820 for discovery (e.g., transmitting/receiving discovery messages). In certain aspects, the processor 804 has circuitry configured to implement the code stored in the computer-readable medium/memory 812. The processor 804 includes circuitry 822 for prioritization (e.g., selection a message to transmit); circuitry 824 for data receiving/transmitting (e.g., data communicating); circuitry 826 for determining a configuration; circuitry 828 for discovery (e.g., transmitting/receiving discovery messages).

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, and/or 5G wireless technologies, aspects of the present disclosure can be applied in other generation-based communication systems.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.8 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication by a first user-equipment (UE), comprising:
determining a first configuration for communication with a second UE of one or more discovery messages on a sidelink channel and a second configuration for data communication with the second UE on the sidelink channel, wherein the first configuration is different than the second configuration; and
communicating with the second UE in accordance with at least one of the first configuration or the second configuration.

2. The method of claim 1, wherein the first configuration for communication of the one or more discovery messages comprises a first discontinuous reception (DRX) pattern, and wherein the second configuration for data communication comprises a second DRX pattern, the first DRX pattern being different than the second DRX pattern.

3. The method of claim 1, wherein the first configuration comprises a configuration of first resources for the communication of the one or more discovery messages, and wherein the second configuration comprises a configuration of second resources for the data communication, the first resources being a different time and frequency than the second resources.

4. The method of claim 1, wherein resources for the communication of the one or more discovery messages is the same as resources for the data communication.

5. The method of claim 1, wherein the first configuration comprises a configuration of a longer periodicity for the communication of the one or more discovery messages as compared to a periodicity for the data communication.

6. The method of claim 1, further comprising receiving one or more messages indicating the first configuration for the communication of the one or more discovery messages and the second configuration for the data communication.

7. The method of claim 6, wherein the one or more messages comprises a message scheduling resources for the communication of the discovery messages, the message comprising a bit indicating that the resources being scheduled are to be used for discovery.

8. The method of claim 6, wherein the one or more messages comprises a message scheduling resources, the message comprising at least two bits indicating that the resources being scheduled are to be used for discovery only, data communication only, or for either discovery or data communication.

9. The method of claim 6, wherein the one or more message comprises a single message indicating the first configuration for the communication of the one or more discovery messages and the second configuration for the data communication.

10. The method of claim 6, wherein the one or more messages comprises a first message indicating the first configuration for the communication of the one or more discovery messages and a second message indicating the second configuration for the data communication.

11. The method of claim 1, wherein determining the first configuration comprises determining a first power control scheme for the communication of the one or more discovery message, wherein determining the second configuration comprises determining a second power control scheme for the data communication, the first power control scheme being different than the second power control scheme.

12. The method of claim 1, wherein determining the first configuration comprises determining to transmit the one or more discovery messages using maximum transmit power.

13. The method of claim 12, wherein determining the second configuration comprises determining a transmit power associated with the data communication based on a power control scheme.

14. The method of claim 1, wherein:
the determination of the first configuration and the second configuration comprises determining at least one of:
a first priority associated with the communication of the one or more discovery messages; and
a second priority associated with the data communication;
the method further comprises selecting whether to transmit the one or more discovery messages or one or more messages for the data communication based on the at least one of the first priority and the second priority; and
the communication with the second UE comprises communicating the one or more discovery messages or the one or more messages for the data communication in accordance with the selection.

15. The method of claim 14, wherein the selection of whether to transmit the one or more discovery messages or the one or more messages for the data communication is in response to resources for the data communication and the communication of the one or more discovery messages overlapping in time.

16. The method of claim 14, wherein the selection comprises selecting to transmit the one or more messages for the data communication if the second priority is greater than the first priority.

17. The method of claim 14, wherein the selection comprises selecting to transmit the one or more messages for the data communication if the first priority is less than a threshold.

18. The method of claim 14, wherein the selection comprises selecting to transmit the one or more messages for the data communication if the second priority is greater than a threshold.

19. The method of claim 14, wherein the one or more messages for the data communication comprise one or more feedback messages on a sidelink feedback channel, and wherein the second priority comprises a priority of a corresponding sidelink shared channel for which the one or more feedback message are to be transmitted.

20. The method of claim 14, wherein the one or more messages for the data communication comprises a transmission on a sidelink broadcast channel, and wherein the second priority associated with the transmission on the sidelink broadcast channel is greater than the first priority associated with the communication of the one or more discovery messages.

21. The method of claim 1, wherein the data communication comprise communication of one or more feedback messages on a sidelink feedback channel, the method further comprising selecting whether to transmit the one or more discovery messages or one or more feedback messages based whether the one or more feedback messages have been sent to a lower layer for transmission.

22. A method for wireless communication, comprising:
determining a first configuration for communication of one or more discovery messages on a sidelink channel between a first UE and a second UE and a second configuration for data communication on the sidelink channel, wherein the first configuration is different than the second configuration; and
transmitting an indication of the first configuration and the second configuration.

23. The method of claim 22, wherein the first configuration for communication of the one or more discovery messages comprises a first discontinuous reception (DRX) pattern, and wherein the second configuration for data communication comprises a second DRX pattern, the first DRX pattern being different than the second DRX pattern.

24. The method of claim 22, wherein the first configuration comprises a configuration of first resources for the communication of the one or more discovery messages, and wherein the second configuration comprises a configuration of second resources for the data communication, the first resources being a different time and frequency than the second resources.

25. The method of claim 22, wherein resources for the communication of the one or more discovery messages is the same as resources for the data communication.

26. The method of claim 22, wherein the first configuration comprises a configuration of a longer periodicity for the communication of the one or more discovery messages as compared to a periodicity for the data communication.

27. The method of claim 22, further comprising transmitting one or more messages indicating the first configuration for the communication of the one or more discovery messages and the second configuration for the data communication.

28. The method of claim 27, wherein the one or more messages comprises a message scheduling resources for the communication of the discovery messages, the message comprising a bit indicating that the resources being scheduled are to be used for discovery.

29. The method of claim 27, wherein the one or more messages comprises a message scheduling resources, the message comprising at least two bits indicating that the resources being scheduled are to be used for discovery only, data communication only, or for either discovery or data communication.

30. The method of claim 27, wherein the one or more message comprises a single message indicating the first configuration for the communication of the one or more discovery messages and the second configuration for the data communication.

31. The method of claim 27, wherein the one or more messages comprises a first message indicating the first configuration for the communication of the one or more discovery messages and a second message indicating the second configuration for the data communication.

32. The method of claim 22, wherein determining the first configuration comprises determining a first power control scheme for the communication of the one or more discovery message, wherein determining the second configuration comprises determining a second power control scheme for the data communication, the first power control scheme being different than the second power control scheme.

33. The method of claim 22, wherein determining the first configuration comprises determining that the one or more discovery messages are to be transmitted using maximum transmit power.

34. The method of claim 33, wherein determining the second configuration comprises determining a transmit power associated with the data communication based on a power control scheme.

35. The method of claim 22, wherein:
the determination of the first configuration and the second configuration comprises determining at least one of:
a first priority associated with the communication of the one or more discovery messages; and
a second priority associated with the data communication.

36. The method of claim 35, wherein the one or more messages for the data communication comprise one or more feedback messages on a sidelink feedback channel, and wherein the second priority comprises a priority of a corresponding sidelink shared channel for which the one or more feedback message are to be transmitted.

37. The method of claim 35, wherein the one or more messages for the data communication comprises a transmission on a sidelink broadcast channel, and wherein the second priority associated with the transmission on the sidelink broadcast channel is greater than the first priority associated with the communication of the one or more discovery messages.

38. An apparatus for wireless communication by a first user-equipment (UE), comprising:
a processing system configured to determine a first configuration for communication with a second UE of one or more discovery messages on a sidelink channel and a second configuration for data communication with the second UE on the sidelink channel, wherein the first configuration is different than the second configuration; and
a transceiver configured to communicate with the second UE in accordance with at least one of the first configuration or the second configuration.

39. An apparatus for wireless communication, comprising:
a processing system configured to determine a first configuration for communication of one or more discovery messages on a sidelink channel between a first UE and a second UE and a second configuration for data communication on the sidelink channel, wherein the first configuration is different than the second configuration; and
a transmitter configured to transmit an indication of the first configuration and the second configuration.

40. An apparatus for wireless communication by a first user-equipment (UE), comprising:
means for determining a first configuration for communication with a second UE of one or more discovery messages on a sidelink channel and a second configuration for data communication with the second UE on the sidelink channel, wherein the first configuration is different than the second configuration; and
means for communicating with the second UE in accordance with at least one of the first configuration or the second configuration.

41. An apparatus for wireless communication, comprising:
means for determining a first configuration for communication of one or more discovery messages on a sidelink channel between a first UE and a second UE and a second configuration for data communication on the sidelink channel, wherein the first configuration is different than the second configuration; and
means for transmitting an indication of the first configuration and the second configuration.

42. A computer-readable medium having instructions stored thereon to cause a first user-equipment (UE) to:
determine a first configuration for communication with a second UE of one or more discovery messages on a sidelink channel and a second configuration for data communication with the second UE on the sidelink channel, wherein the first configuration is different than the second configuration; and
communicate with the second UE in accordance with at least one of the first configuration or the second configuration.

43. A computer-readable medium having instructions stored thereon to cause an apparatus to:
determine a first configuration for communication of one or more discovery messages on a sidelink channel between a first UE and a second UE and a second configuration for data communication on the sidelink channel, wherein the first configuration is different than the second configuration; and
transmit an indication of the first configuration and the second configuration.
